(19) United States
(12) Patent Application Publication
(10) Pub. No.: US 2023/0294452 A1
(43) Pub. Date: Sep. 21, 2023

(54) Automotive Spoke Wheel Spinner Locking System

(71) Applicants: Gerald Lehman, Compton, CA (US); DNA Specialty, Compton, CA (US)

(72) Inventor: Gerald Lehman, Buena Park, CA (US)

(21) Appl. No.: 18/187,532

(22) Filed: Mar. 21, 2023

Related U.S. Application Data
(60) Provisional application No. 63/322,128, filed on Mar. 21, 2022.

(51) Int. Cl. B60B 3/14; B60B 27/06

(52) U.S. Cl. CPC B60B 3/142; B60B 27/065; B60B 2900/3318

(57) ABSTRACT

An automotive spoke wheel spinner locking system includes an adapter, a knock-off cap, and a plurality of male fasteners. The adapter includes a mounting plate, a wheel hub, and a central opening. The wheel hub is concentrically positioned and adjacently mounted to the mounting plate. The central opening traverses through the mounting plate and the wheel hub. The knock-off cap includes a central plate, a lateral wall, and a spinner aperture. The lateral wall is radially connected around the central plate as the spinner aperture concentrically traverses through the central plate. The knock-off cap is concentrically positioned to the adapter, wherein the lateral wall is threadedly attached around the wheel hub, and the center plate is mounted to the wheel hub by the plurality of male fasteners.

### FIELD OF THE INVENTION

The present invention generally relates to a locking system for automotive wheels. More specifically, the present invention relates to a lockable threaded cap that allows securing of an automotive spoke wheel.

### BACKGROUND OF THE INVENTION

Automotive attachments are currently in high demand. Automobile wheels held in place by spinner nuts, also called spinners, are a familiar sight on racing and competition vehicles, and various sports cars are equipped with wire wheels or spoke wheels mounted to the vehicle using spinner nuts. Wheels of this type are commonly referred to as “knock-off wheels.”

As the automotive industry has developed increasingly costly and sought-after wheels, including spoked wheels, the lack of associated preventive measures presents an open invitation for theft. A number of conventional automobiles have been provided with the spoked wheels as well as caps that use a spinner nut to impart a sporty or competitive appearance. Such spinner nuts have also been sold as aftermarket accessories.

The spinner nuts that hold a wheel to its hub are subject to stress and vibration that tend to loosen them, increasing the risk of the wheel assembly's detaching from the vehicle while it is moving. What's more, loose spinner nuts allow easy removal of the wheel assembly, exposing the vehicle's owner to an increased risk of theft. Many types of wheel attachments have been used to allow quick removal and installation of automotive wheels, but they have generally not used a locking mechanism to prevent loosening of the spinner nuts attached to the adapter. In addition, conventional spinner nuts are usually screwed onto the adapter and thus are difficult to install—sometimes requiring hammer blows to tighten.

A means is thus needed of locking spinner nuts in place that considers the normal stresses exerted on spinner nuts while allowing secure installation. The present invention aims to solve these problems and/or improve on the conventional wheel assembly through innovative construction of a spinner nut assembly intended to provide substantively improved protection against theft and reduce the risk of spinner nuts' loosening unexpectedly while also allowing convenient installation.

### BRIEF DESCRIPTION OF THE DRAWINGS

FIG. 1 is a perspective view of the present invention without the spinner tool body.

FIG. 2 is an exploded view of the present invention without the spinner tool body.

FIG. 3 is a front perspective view of the adapter of the present invention.

FIG. 4 is a rear perspective view of the adapter of the present invention.

FIG. 5 is a rear perspective view of the knock-off cap of the present invention.

FIG. 6 is a front view of the knock-off cap of the present invention, showing the plane upon which a cross sectional view is taken shown in FIG. 7.

FIG. 7 is a cross section view of the knock-off cap of the present invention taken along line 7-7 of FIG. 6.

FIG. 8 is a front perspective view of the knock-off cap with the pair of spokes.

FIG. 9 is a front perspective view of the knock-off cap with the plurality of spokes.

FIG. 10 is a front perspective view of the adapter, the knock-off cap, and the spinner tool body.

### DETAIL DESCRIPTIONS OF THE INVENTION

All illustrations of the drawings are for the purpose of describing selected versions of the present invention and are not intended to limit the scope of the present invention.

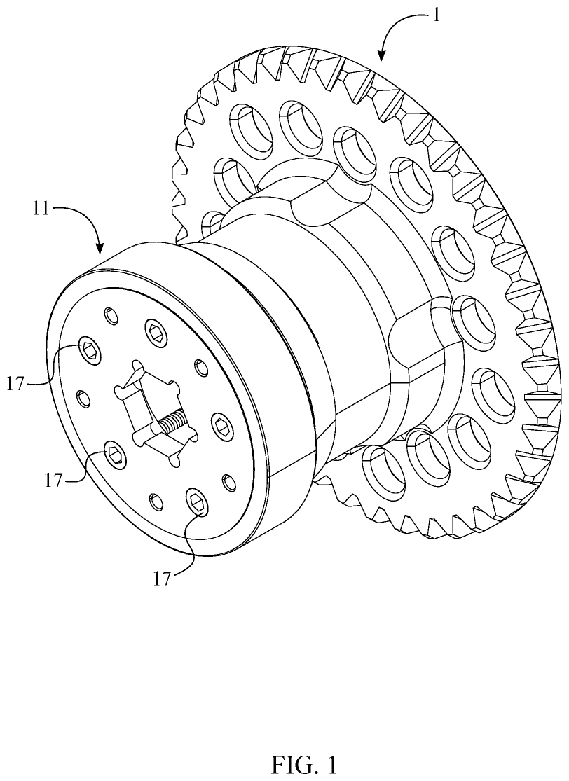

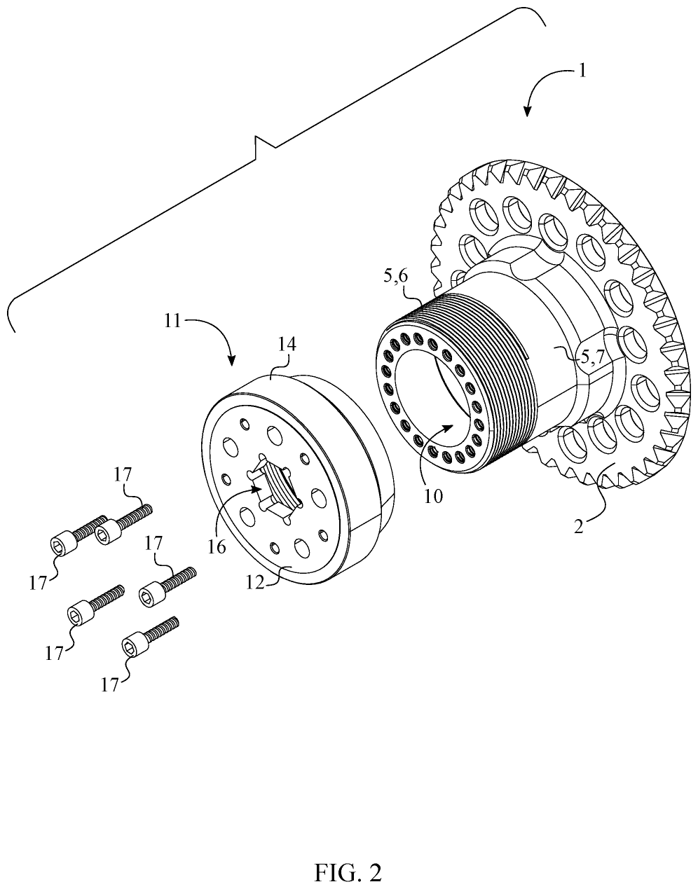

The present invention provides a spoke wheel spinner locking system to allow securing of an automotive spoke wheel, also known as the knock-off wheels. As shown in FIG. 1 and FIG. 2, the present invention comprises an adapter 1, a knock-off cap 11, and a plurality of male fasteners 17. The knock-off cap 11 structurally upgrades over the existing design of the threaded cap so that the user can easily mount or remove the knock-off wheels without damaging the knock-off cap 11. Furthermore, the plurality of male fasteners 17 functions as an additional securing mechanism between the knock-off cap 11 and the adapter 1 to prevent unintentional detachment and theft of the knock-off wheels.

In reference to the general configuration of the present invention, the adapter 1 that secures the present invention to the existing hub assembly of the vehicle comprises a mounting plate 2, a wheel hub 5, and a central opening 10. The knock-off cap 11 that secures the knock-off wheel to the adapter 1 comprises a center plate 12, a lateral wall 14, and a spinner aperture 16. As shown in FIG. 1 and FIG. 2, the wheel hub 5 is concentrically positioned to the mounting plate 2 and adjacently connected to the mounting plate 2. The central opening 10 traverses through the mounting plate 2 and the wheel hub 5 thus allowing the wheel hub 5 to be centrally positioned around the existing hub assembly, and the mounting plate 2 to be secured to the existing hub assembly. The lateral wall 14 is radially connected around the center plate 12 so that the general shape of the knock-off cap 11 can be formed. When the knock-off wheel is placed on the adapter 1, the knock-off cap 11 is concentrically positioned to the adapter 1 so that the lateral wall 14 can be threadedly attached around the wheel hub 5. Then, the center plate 12 can be mounted to the wheel hub 5 by the plurality of male fasteners 17 to further secure the mounting of the knock-off wheel and the attachment of the knock-off cap 11. The spinner aperture 16 concentrically traverses through the center plate 12 to assist with the rotational attachment or detachment of the knock-off cap 11. In other words, the configuration of the spinner aperture 16 enables the user to use a torque tool rather than the traditional hammering method that tighten or loosen the knock-off cap 11.

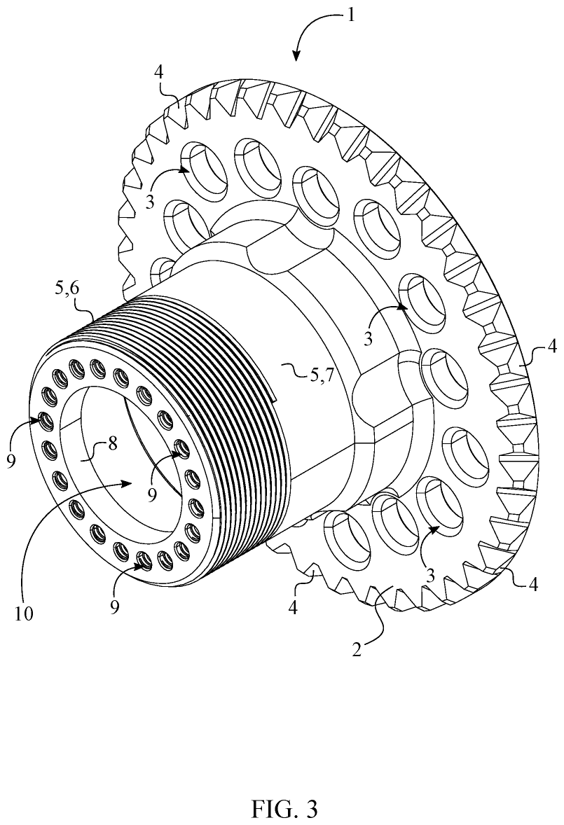

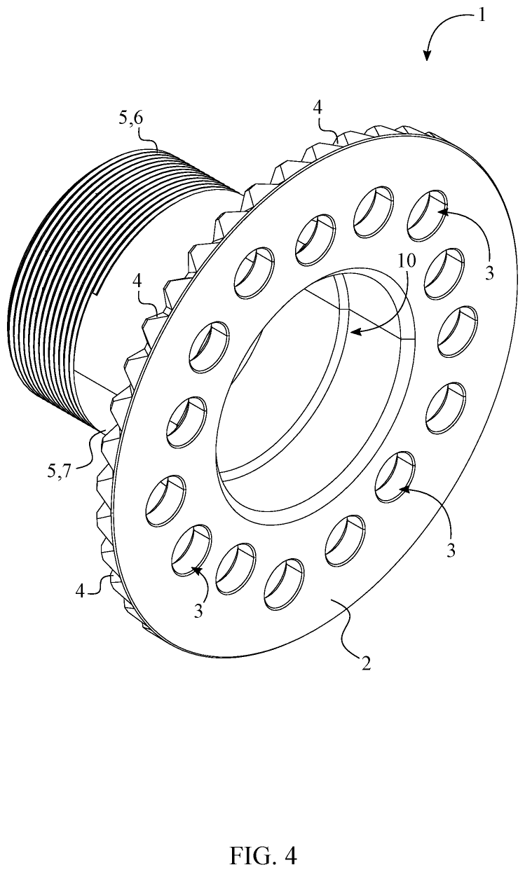

The adapter 1 is configured to mount the present invention onto the existing hub assembly. In reference to FIG. 3 and FIG. 4, the adapter 1 may further comprise a plurality of bolt openings 3 to assist the mounting process of the adapter 1. More specifically, the plurality of bolt openings 3 is radially positioned around the wheel hub 5 and normally traverses through the mounting plate 2. The mounting plate 2 is a disk-shaped rigid body that can be positioned against the existing hub assembly. The existing hub studs of the vehicle are able to traverse through the plurality of bolt openings 3 thus allowing the lug nuts to fully secure the adapter 1 onto the existing hub assembly. Once the adapter 1 is secured to the existing hub assembly, rotational movement of the hub assembly can be axially transferred onto the mounting plate 2 and the wheel hub 5 that is outwardly oriented from the mounting plate 2. Furthermore, the wheel hub 5 is formed into a cylindrical body and provides necessary surface area to precisely position the knock-off wheels onto the adapter 1 without any lateral movement.

In reference to FIG. 3, the adapter 1 may further comprise a plurality of alignment indentations 4. The plurality of alignment indentations 4 is perimetrically positioned around the mounting plate 2 and radially traverses into the mounting plate 2. More specifically, the plurality of alignment indentations 4 corresponds to the existing alignment teeth of the knock-off wheel to safeguard the mounting process of the knock-off wheels. Furthermore, the plurality of alignment indentations 4 and the existing alignment teeth ensure that the adapter 1 and the knock-off wheel are able to maintain the same rotational speed when the vehicle is driven.

In reference to FIG. 3, the wheel hub 5 may comprise a threaded section 6, a non-threaded section 7, a flange 8, and a plurality of female fasteners 9. The non-threaded section 7 is terminally connected to the mounting plate 2. The threaded section 6 is terminally connected to the non-threaded section 7, opposite of the mounting plate 2. More specifically, when the knock-off wheel is positioned around the wheel hub 5, the non-threaded section 7 is fully enclosed by the center bore of the knock-off wheel. Resultantly, the threaded section 6 extends pass the center bore of the knock-off wheel so that the lateral wall 14 can be threadedly attached around the threaded section 6. The flange 8 is perimetrically positioned within the threaded section 6 and functions as inner structural rim that mounts with the plurality of male fasteners 17. More specifically, the flange 8 and the mounting plate 2 are oppositely positioned of each other about the wheel hub 5 as the flange 8 is oriented towards the central opening 10 and radially connected to the threaded section 6. The plurality of female fasteners 9 is radially positioned within the threaded section 6 and normally traverses through the flange 8. As a result, each of the plurality of male fasteners 17 is able to attach to each of the plurality of female fasteners 9 through the center plate 12.

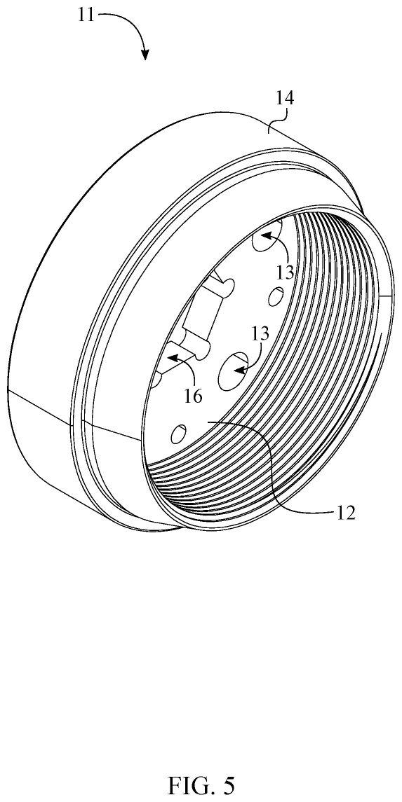

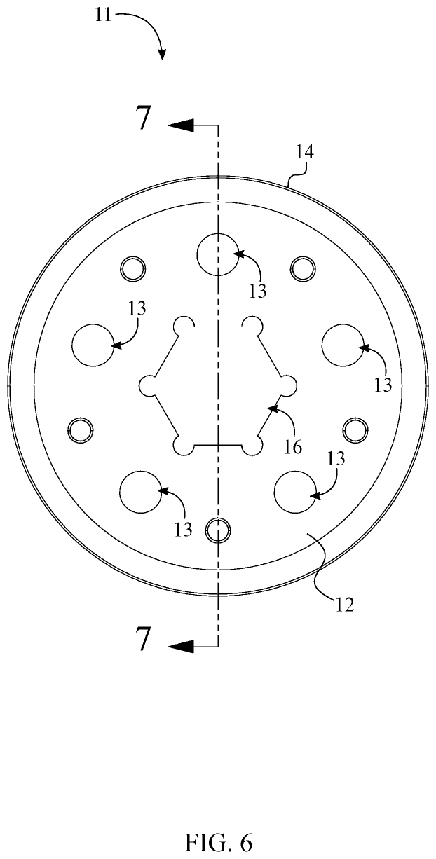

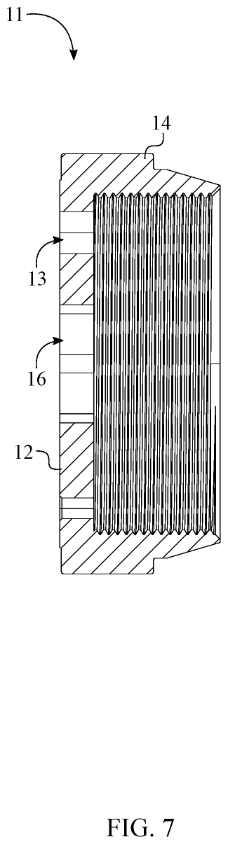

The knock-off cap 11 secures the knock-off wheel to the adapter 1 as the lateral wall 14 is threadedly attached to the threaded section 6 and the center plate 12 is positioned adjacent to the flange 8. In other words, the lateral wall 14 continuously threads onto the threaded section 6 until the center plate 12 is pressed against the flange 8 and the knock-off cap 11 is unable to rotate anymore. In reference to FIGS. 5-7, the knock-off cap 11 may further comprise a plurality of fastener-receiving openings 13 so that each of the plurality of male fasteners 17 can traverse through the center plate 12. The plurality of fastener-receiving openings 13 is radially positioned around the spinner aperture 16 and traverses through the center plate 12. As a result, each of the plurality of male fasteners 17 is attached to a corresponding female fastener of the plurality of female fasteners 9 through a corresponding opening of the plurality of fastener-receiving openings 13 when the knock-off wheel is mounted.

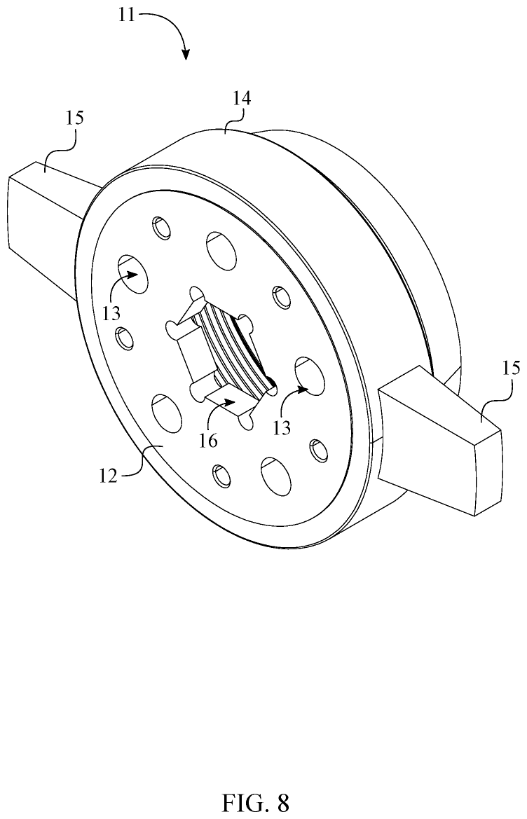

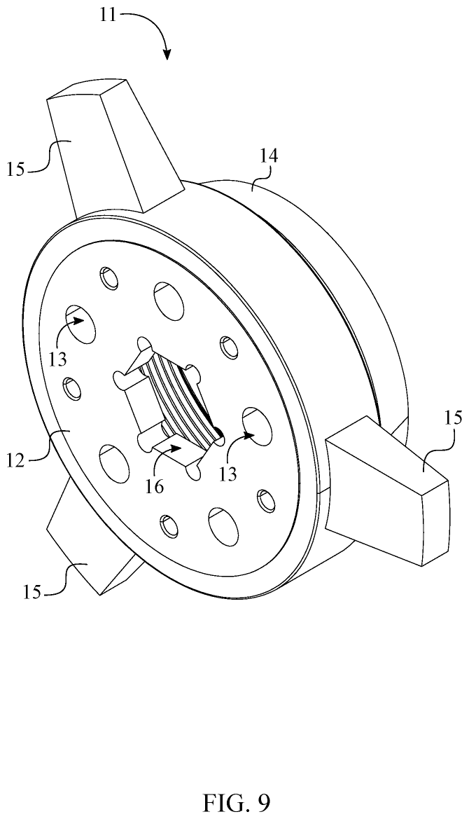

In reference to FIG. 8 and FIG. 9, the knock-off cap 11 may further comprise at least one spoke 15 that can be an esthetic design body or a structural body that can withstand hammering process of a lead hammer. More specifically, the at least one spoke 15 is laterally connected onto the lateral wall 14 and outwardly oriented from the lateral wall 14. In some embodiment of the knock-off cap 11, the at least one spoke 15 is a pair of spokes. As shown in FIG. 8, each spoke of the pair of spokes is positioned diametrically oppose of each other about the center plate 12. In some embodiment of the knock-off cap 11, the at least one spoke 15 is a plurality of spokes. As shown in FIG. 9, each of the plurality of spokes is radially positioned around the center plate 12.

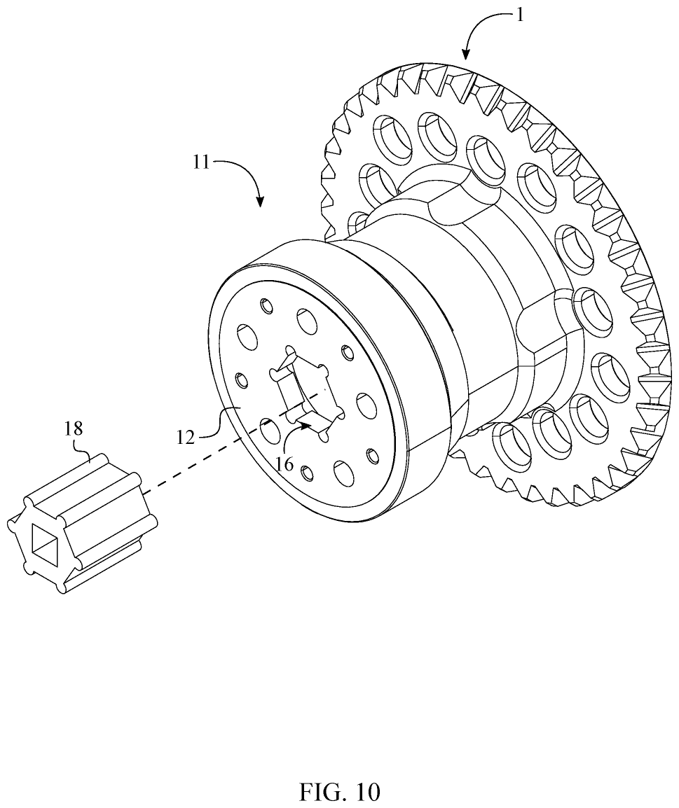

In reference to FIG. 10, the present invention may further comprise a spinner tool body 18. Preferably, the spinner tool body 18 is formed similar to a male-socket that can be attached to the torque tool. The spinner tool body 18 is operatively coupled within the spinner aperture 16, wherein the rotation of the spinner tool body 18 simultaneously rotate the knock-off cap 11. Furthermore, an outer profile of the spinner tool body 18 corresponds to an inner profile of the spinner aperture 16 so that the engagement between the spinner tool body 18 and the spinner aperture 16 is an exact fit. For example, when inner profile of the spinner aperture 16 is formed into a hexagonal shape, the outer profile of the spinner tool body 18 is also formed into a hexagonal shape that can be inserted into the inner profile of the spinner aperture 16. As explained before, the user can easily attach or remove the knock-off cap 11 via the engagement between the spinner tool body 18 and the spinner aperture 16 instead of using traditional hammering process.

Although the invention has been explained in relation to its preferred embodiment, it is to be understood that many other possible modifications and variations can be made without departing from the spirit and scope of the invention as hereinafter claimed.

What is claimed is:

1. An automotive spoke wheel spinner locking system comprising:
an adapter;
a knock-off cap;
a plurality of male fasteners;
the adapter comprising a mounting plate, a wheel hub, and a central opening;
the knock-off cap comprising a center plate, a lateral wall, and a spinner aperture;
the wheel hub being concentrically positioned to the mounting plate;
the wheel hub being adjacently connected to the mounting plate;
the central opening traversing through the mounting plate and the wheel hub;
the lateral wall being radially connected around the center plate;
the spinner aperture concentrically traversing through the center plate;
the knock-off cap being concentrically positioned to the adapter;
the lateral wall being threadedly attached around the wheel hub; and
the center plate being mounted to the wheel hub by the plurality of male fasteners.

2. The automotive spoke wheel spinner locking system as claimed in claim 1 comprising:
the adapter further comprising a plurality of bolt openings;
the plurality of bolt openings being radially positioned around the wheel hub; and
the plurality of bolt openings normally traversing through the mounting plate.

3. The automotive spoke wheel spinner locking system as claimed in claim 1 comprising:
the adapter further comprising a plurality of alignment indentations;
the plurality of alignment indentations being perimetrically positioned around the mounting plate; and
the plurality of alignment indentations radially traversing into the mounting plate.

4. The automotive spoke wheel spinner locking system as claimed in claim 1 comprising:
the wheel hub comprising a threaded section, a non-threaded section, a flange, and a plurality of female fasteners;
the non-threaded section being terminally connected to the mounting plate;
the threaded section being terminally connected to the non-threaded section, opposite of the mounting plate;
the flange being perimetrically positioned within the threaded section;
the flange being radially connected to the threaded section;
the plurality of female fasteners being radially positioned within the threaded section; and
the plurality of female fasteners being normally traversing through the flange.

5. The automotive spoke wheel spinner locking system as claimed in claim 1 comprising:
the knock-off cap further comprising a plurality of fastener-receiving openings;
the plurality of fastener-receiving openings being radially positioned around the spinner aperture; and
the plurality of fastener-receiving openings traversing through the center plate.

6. The automotive spoke wheel spinner locking system as claimed in claim 1 comprising:
the knock-off cap further comprising at least one spoke;
the at least one spoke being laterally connected onto the lateral wall; and
the at least one spoke being outwardly oriented from the lateral wall.

7. The automotive spoke wheel spinner locking system as claimed in claim 1 comprising:
a spinner tool body; and
the spinner tool body being operatively coupled within the spinner aperture, wherein the rotation of the spinner tool body simultaneously rotates the knock-off cap.

8. The automotive spoke wheel spinner locking system as claimed in claim 7, wherein an outer profile of the spinner tool body corresponds to an inner profile of the spinner aperture.

9. The automotive spoke wheel spinner locking system as claimed in claim 1 comprising:
the wheel hub further comprising a plurality of female fasteners;
the knock-off cap further comprising a plurality of fastener-receiving openings;
the lateral wall being threadedly attached around a threaded section of the wheel hub;
the center plate being positioned adjacent to a flange of the wheel hub; and
each of the plurality of male fasteners being attached to a corresponding female fastener of the plurality of female fasteners through a corresponding opening of the plurality of fastener-receiving openings.

10. An automotive spoke wheel spinner locking system comprising:
an adapter;
a knock-off cap;
a plurality of male fasteners;
a spinner tool body;
the adapter comprising a mounting plate, a wheel hub, and a central opening;
the knock-off cap comprising a center plate, a lateral wall, and a spinner aperture;
the wheel hub being concentrically positioned to the mounting plate;
the wheel hub being adjacently connected to the mounting plate;
the central opening traversing through the mounting plate and the wheel hub;
the lateral wall being radially connected around the center plate;
the spinner aperture concentrically traversing through the center plate;
the knock-off cap being concentrically positioned to the adapter;
the lateral wall being threadedly attached around the wheel hub;
the spinner tool body being operatively coupled within the spinner aperture, wherein the rotation of the spinner tool body simultaneously rotates the knock-off cap; and
the center plate being mounted to the wheel hub by the plurality of male fasteners.

11. The automotive spoke wheel spinner locking system as claimed in claim 10 comprising:
the adapter further comprising a plurality of bolt openings;
the plurality of bolt openings being radially positioned around the wheel hub; and
the plurality of bolt openings normally traversing through the mounting plate.

12. The automotive spoke wheel spinner locking system as claimed in claim 10 comprising:
the adapter further comprising a plurality of alignment indentations;
the plurality of alignment indentations being perimetrically positioned around the mounting plate; and
the plurality of alignment indentations radially traversing into the mounting plate.

13. The automotive spoke wheel spinner locking system as claimed in claim 10 comprising:
the wheel hub comprising a threaded section, a non-threaded section, a flange, and a plurality of female fasteners;
the non-threaded section being terminally connected to the mounting plate;
the threaded section being terminally connected to the non-threaded section, opposite of the mounting plate;
the flange being perimetrically positioned within the threaded section;
the flange being radially connected to the threaded section;
the plurality of female fasteners being radially positioned within the threaded section; and
the plurality of female fasteners being normally traversing through the flange.

14. The automotive spoke wheel spinner locking system as claimed in claim 10 comprising:
the knock-off cap further comprising a plurality of fastener-receiving openings;
the plurality of fastener-receiving openings being radially positioned around the spinner aperture; and
the plurality of fastener-receiving openings traversing through the center plate.

15. The automotive spoke wheel spinner locking system as claimed in claim 10 comprising:
the knock-off cap further comprising at least one spoke;
the at least one spoke being laterally connected onto the lateral wall; and
the at least one spoke being outwardly oriented from the lateral wall.

16. The automotive spoke wheel spinner locking system as claimed in claim 10, wherein an outer profile of the spinner tool body corresponds to an inner profile of the spinner aperture.

17. The automotive spoke wheel spinner locking system as claimed in claim 10 comprising:
the wheel hub further comprising a plurality of female fasteners;
the knock-off cap further comprising a plurality of fastener-receiving openings;
the lateral wall being threadedly attached around a threaded section of the wheel hub;
the center plate being positioned adjacent to a flange of the wheel hub; and
each of the plurality of male fasteners being attached to a corresponding female fastener of the plurality of female fasteners through a corresponding opening of the plurality of fastener-receiving openings.
